(19) United States
(12) Patent Application Publication
(10) Pub. No.: US 2009/0240713 A1
(43) Pub. Date: Sep. 24, 2009

(54) System and Method for Validating Enterprise Information Handling System Network Solutions

(76) Inventors: Fenghua Jia, Round Rock, TX (US); Jason Wallis, Round Rock, TX (US); Robert Hayes, Cedar Park, TX (US); Sreenivas Sathyanarayana, Austin, TX (US); Hsinlin Lai, Austin, TX (US); Greg Murray, Round Rock, TX (US); Hemant Deshpande, Round Rock, TX (US); Jayavel Somasundaram, Austin, TX (US)

Correspondence Address: HAMILTON & TERRILE, LLP, P.O. BOX 203518, AUSTIN, TX, 78720, US

(21) Appl. No.: 12/053,718

(22) Filed: Mar. 24, 2008

(51) Int. Cl. G06F 17/30

(52) U.S. Cl. 707/100; 707/E17.005

(57) ABSTRACT

Enterprise information handling system network solutions are automatically validated within each information handling system, between connected information handling systems and to logical groupings within the solution and to the solution as a whole. A validation engine applies validation rules to determine a network solution topology to validate end user information handling system component selections. Invalid information handling system component selections are automatically corrected, disabled or hidden to ensure that end users select valid configurations.

### BACKGROUND OF THE INVENTION

1. Field of the Invention

The present invention relates in general to the field of information handling system interactions, and more particularly to a system and method for validating enterprise information handling system network solutions.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Business enterprises have come to rely upon information handling systems in order to perform enterprise functions in an effective and efficient manner. One result of the growing reliance of enterprises on information handling systems is that enterprises have generated and continue to generate large quantities of information that needs management and storage. In response to increased enterprise storage needs, industry has developed a variety of enterprise solutions that manage and store information with networked information handling systems and supporting devices, such as networked hard disk drives. Generally, enterprises prefer enterprise solutions that are scalable so that additional management and storage devices are added as needed to provide rapid access to information when the information is needed. Another feature commonly sought by enterprises is redundancy, such as by keeping multiple copies of information within a storage solution so that failure of any one storage device will not make information inaccessible. One type of enterprise storage solution often preferred by enterprises is a storage area network (SAN). SANs are often interfaced with Fibre channel cables that provide for rapid communication of information between storage devices through host bus adapters (HBAs), Fibre channel switches and disk or storage processor enclosures (DPEs or SPEs). SANs are typically deployed in redundant or non-redundant topologies. Another type of enterprise storage topology is direct attached storage (DAS).

One difficulty that enterprises face in setting up and using networked enterprise information handling system solutions is configuring components of a solution in a compatible manner. For example, different combinations of HBAs, switches, DPEs and SPEs call for different types of cables for connecting devices. Often, when ordering networked information handling system enterprise solutions, end users have confusion about the types of components to select and how the selected components will interconnect. An overall enterprise solution is often difficult for end users to visualize since an enterprise solution often includes large numbers of components. In the event that an end user purchases incompatible components, such as incorrect cables, the end user often places responsibility for the incompatible components on the information handling system manufacturer even if the end user was required to manually validate the compatibility of the components of the enterprise solution. Active management by manufacturer sales representatives tends to reduce such errors, however, this also increases the cost of completing enterprise orders since manual validation of an enterprise solution is time consuming. Even with active manufacturer input to the components purchased by an end user, mistakes still happen since manual selection and mapping of multiple components is a tedious process prone to errors.

### SUMMARY OF THE INVENTION

Therefore a need has arisen for a system and method which automatically validates the compatibility of end user configurations of networked information handling system enterprise solutions from a plurality of components.

In accordance with the present invention, a system and method are provided which substantially reduce the disadvantages and problems associated with previous methods and systems for validation of networked information handling system enterprise solutions. Information handling system component selections for a networked enterprise solution are analyzed by validation rules to ensure that end user component selections result in a valid enterprise solution.

More specifically, an enterprise validation system applies validation rules to end user information handling system component selections to ensure compatibility within each ordered information handling system, between each connected information handling system and within a logical storage group, a direct attached storage group, a storage area network group, or within the solution as a whole. A selector interface presents information handling system components from a component database to an end user and accepts end user selections. A validation engine applies validation rules from a rules database to the end user selections to ensure that the selections provide an enterprise solution with compatible components for a valid configuration. If an invalid selection is made, the enterprise solution configuration is automatically corrected or a message explaining the invalid selection and possible corrections is presented to the end user. The validation rules that are applied may vary based on a configuration topology determination for the enterprise solution, such as selection of a direct attached storage, non-redundant storage area network or redundant storage area network topology.

The present invention provides a number of important technical advantages. One example of an important technical advantage is that end user configurations of networked information handling systems are automatically validated with little or no manufacturer help. Automatically applied validation rules ensure compatibility at a device level, between connected devices and at certain logical storage groupings, based on an automatically determined topology, and to the solution as a whole. A graphical user interface automatically presents validation errors with user-friendly error messages and proposed corrections. In some instances, auto-fix, auto-disable or auto-hide validation rules help to guide end users through selection of valid and compatible configurations. This simplifies end user purchases of networked information handling system enterprise solutions with reduced costs and provides a favorable end user experience with decreased risk that enterprise solutions will ship with incompatible components.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a networked information handling system enterprise solution;

FIG. 2 depicts a block diagram of a system for validation of end user information handling system component selections for a networked information handling system enterprise solution;

FIG. 3 depicts a flow diagram of a process for validation of a networked information handling system enterprise solution;

FIG. 4 depicts a graphical user interface presented to an end user for validation of a networked information handling system enterprise solution.

### DETAILED DESCRIPTION

Networked information handling system enterprise solutions are automatically validated to ensure compatibility of end user information handling system component selections. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

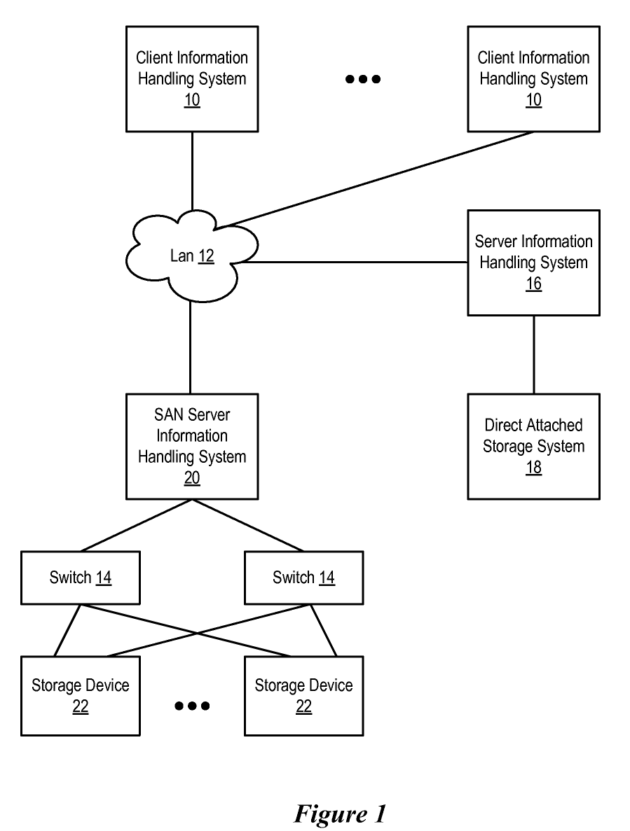

Referring now to FIG. 1, a block diagram depicts a networked information handling system enterprise solution. Plural client information handling systems 10 interface through a local area network (LAN) 12 to communicate information with each other and with other networked devices. LAN 12 supports server information handling systems 16. Server information handling systems 16 coordinate access by client information handling systems 10 to stored information, such as enterprise level database storage or email applications. Enterprise information is stored in a variety of topologies. One example of an enterprise storage topology is direct attached storage (DAS) 18, which includes storage devices, such as hard disk drives, that attach directly to server information handling system 16 without an intervening storage network, through a variety of components, such as iSCSI Ethernet, Fibre channel, or Serial Attached SCSI cables, various storage device processors and host bus adapters (HBAs). Another example of an enterprise storage topology is a storage area network (SAN) that has a SAN server information handling system to coordinate access with networked storage devices 22. SAN topologies consist of non-redundant topologies and redundant topologies, which include redundant components to compensate for a failure of a component, such as multiple switches 14 and multiple storage devices 22. Storage devices interface through a variety of components, such as iSCSI Ethernet or Fibre channel cables, various storage device processors and host bus adapters (HBAs). One difficulty faced by an enterprise when purchasing a networked information handling system enterprise solution is ensuring compatibility of the components used to build the solution, such as hardware and software components within server information handling systems 16 and direct attached storage 18 and storage area network information handling system 20, switches 14, and storage device system 22.

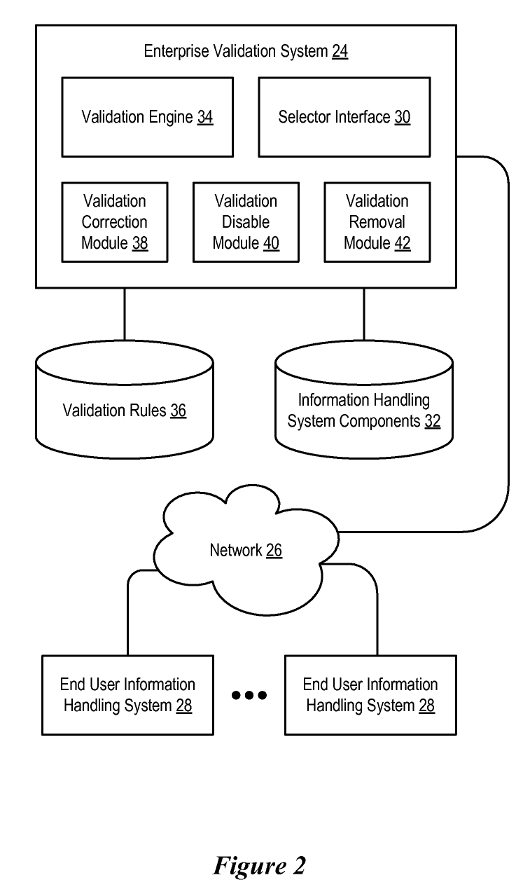

Referring now to FIG. 2, a block diagram depicts a system for validation of end user information handling system component selections for a networked information handling system enterprise solution. An enterprise validation system 24 is accessed through a network 26, such as the Internet, by end user information handling systems 28, such as by end users seeking to purchase a solution or a manufacture representative seeking to aid an end user in a purchase. A selector interface 30 presents the end user with information handling system components for selection to order an enterprise solution from an information handling system components database 32. For example, information handling system components include hardware to build individual information handling systems, such as CPUs, memory, internal storage, graphics, etc. software to run on information handling systems, such as operating systems or other applications, and cables and components to interconnect devices. As selections are input through selector interface 30, a validation engine 34 applies rules from a validation rules database 36 to validate the information handling system component selections. Validation engine 34 applies rules to ensure that valid configuration of components is selected, i.e., that the components are compatible with each other, within each configuration information handling system, between each connected information handling system and for logical, relevant storage groups and the solution as a whole.

As an example, a validation rule within each information handling system ensures that the processor and memory assets of an information handling system are adequate to run an application loaded on an information handling system. A validation rule between each information handling system ensures that the processor and memory assets of that information handling system are adequate to meet communication demands from a selected number of other information handling systems. A validation rule for connections between information handling systems compares interface units and cables to ensure that compatible components are able to communicate with each other. In one embodiment, a validation rule applies attributes of selected components to determine a topology associated with the selected components, such as a direct attached storage, non-redundant storage area network and redundant storage area network topology. Based upon a detected topology, validation rules associated with the detected topology are used to determine the compatibility with other selected components. A validation correction module 38 monitors end user information handling system component selections to detect and automatically correct the selection of incompatible components by replacing incompatible selections with compatible selections. A validation disable module 40 detects available component selections presented to an end user and disables the selections from the presentation to the end user so that the end user cannot select an invalid component. A validation removal module 42 detects available components selections presented to an end user and removes incompatible components from the presentation of available selections to the end user.

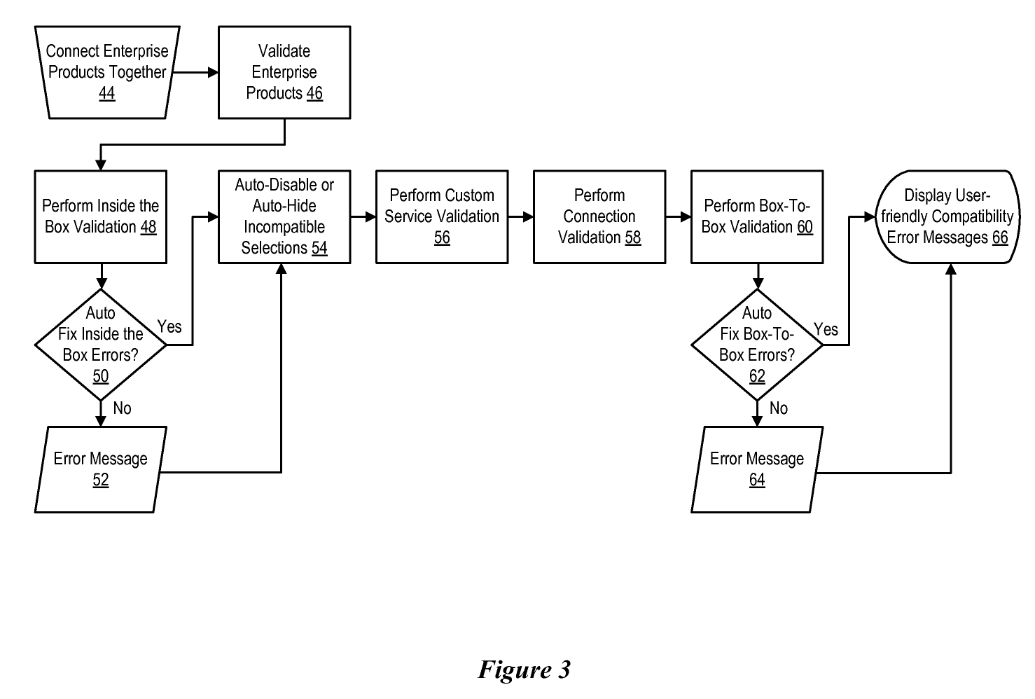

Referring now to FIG. 3, a flow diagram depicts a process for validation of a networked information handling system enterprise solution. The process begins at step 44 with an end user selection to connect selected enterprise devices together at a graphical user interface. At step 46, a validation of the enterprise solution is initiated. At step 48, the validation begins with an inside-the-box validation of the components selected for each individual information handling system to ensure the compatibility of the components selected to build that information handling system. At step 50, a determination is made as to whether to auto-fix any incompatible selections of components within any information handling system having incompatible components. If an auto-fix is not performed, the process continues to step 52 to present an error message so that an end user can correct the selection of the incompatible components within the information handling system having the detected incompatibility.

At step 54, incompatible components are automatically disabled or hidden to prevent selection by an end user. At step 56, a validation is performed for customized service selections, so as to ensure compatibility of selected service components with existing service components of an enterprise solution already in place by the end user. At step 58, a connection validation is performed to ensure that selected components of an information handling system are compatible with selected components of other information handling systems connected by cables or controllers. At step 60, a box-to-box validation is performed to ensure that the configuration of each information handling system is compatible with other information handling systems at the storage group level, at the DAS or SAN group level depending on the automatically determined topology, and to the enterprise solution as a whole. At step 62, a determination is made of whether to perform an auto fix for incompatibilities detected between information handling systems or for connections of information handling system. If an auto fix of incompatibilities is not performed, the process continues to step 64 to present an error message for the end user to address the incompatibilities. At step 66, user-friendly error messages are presented to explain information handling system component incompatibilities.

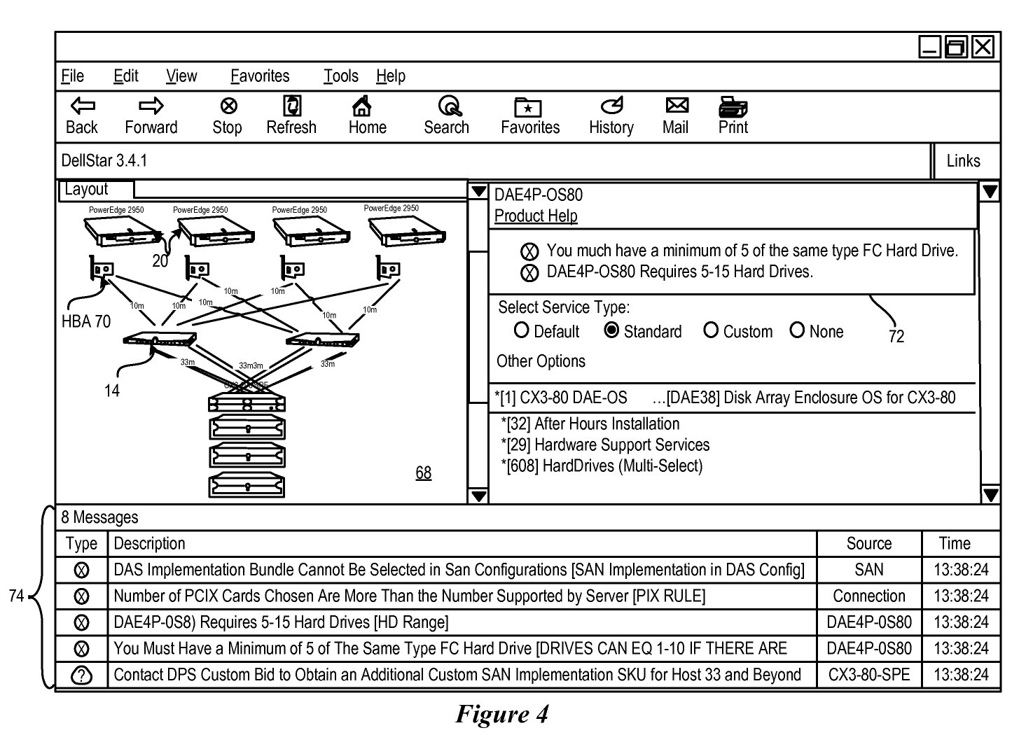

Referring now to FIG. 4, a graphical user interface presented to an end user for validation of a networked information handling system enterprise solution is depicted. A topology window 68 depicts the selected information handling systems, such as servers 20, switches 14 and HBAs 70, with their associated connections. Validation windows 72 and 74 present specific issues with the configuration selected by an end user, such as incompatible components and corrective actions available to complete a valid configuration.

Although the present invention has been described in detail, it should be understood that various changes, substitutions and alterations can be made hereto without departing from the spirit and scope of the invention as defined by the appended claims.

What is claimed is:

1. A system for validating a configuration of networked information handling systems, the system comprising:
a selector interface operable to accept end user information handling system selections from plural available information handling system components;
validation rules defining valid configurations within an information handling system, between information handling systems and connecting information handling systems; and
a validation engine interfaced with the selector interface and the validation rules, the validation engine operable to automatically apply the validation rules to information handling system component selections to validate components within a selected information handling system, between plural selected information handling systems and connecting plural information handling systems.

2. The system of claim 1 wherein the validation engine applies the validation rules by automatically determining a topology associated with the information handling system components to apply validation rules associated with the determined topology.

3. The system of claim 2 wherein the topology comprises direct attached storage.

4. The system of claim 2 wherein the topology comprises a storage area network.

5. The system of claim 4 wherein the storage area network comprises a redundant storage area network and the validation rule comprises a plurality of switches.

6. The system of claim 4 wherein the storage area network comprises a non-redundant storage area network.

7. The system of claim 1 further comprising a validation correction module operable to detect an invalid information handling system component selection and to replace the invalid selection with a valid selection.

8. The system of claim 1 further comprising a validation disable module operable to identify invalid information handling system component options and to disable the invalid options from selection by an end user.

9. The system of claim 1 further comprising a validation removal module operable to identify invalid information handling system component options to remove the invalid options from selection by an end user.

10. The system of claim 1 wherein the information handling system components comprise interconnection devices operable to interconnect information handling systems.

11. A method for validating a configuration of networked information handling systems, the method comprising:
presenting plural available information handling system components to an end user;
accepting information handling system component selections from the end user; and
automatically applying validation rules to the information handling system component selections to validate the components within a selected information handling system, between plural selected information handling systems and for connecting plural information handling systems.

12. The method of claim 11 wherein applying the validation rules further comprises automatically determining a topology associated with the information handling system components to apply validation rules associated with the determined topology.

13. The method of claim 12 wherein the topology comprises direct attached storage.

14. The method of claim 12 wherein the topology comprises a storage area network.

15. The method of claim 14 wherein the storage area network comprises a redundant storage area network and the validation rule comprises a plurality of switches.

16. The method of claim 14 wherein the topology comprises a storage area network redundant topology and the interconnection device comprises plural switches.

17. The method of claim 14 wherein the storage area network comprises a non-redundant storage area network.

18. The method of claim 11 further comprising:
identify invalid information handling system component options; and
disabling the invalid options from selection by an end user.

19. The method of claim 11 further comprising:
identify invalid information handling system component options; and
removing the invalid options from selection by an end user.

20. The method of claim 11 further comprising:
detect an invalid information handling system component selection; and
replacing the invalid selection with a valid selection.
